(19) United States
(12) Patent Application Publication
(10) Pub. No.: US 2014/0300534 A1
(43) Pub. Date: Oct. 9, 2014

(54) INPUT DEVICE OF ELECTRONIC DEVICE AND SETTING METHOD THEREOF

(71) Applicant: Acer Incorporated, New Taipei City (TW)

(72) Inventors: Meng-Shih Tsai, New Taipei City (TW); Chueh-Pin Ko, New Taipei City (TW)

(73) Assignee: Acer Incorporated, New Taipei City (TW)

(21) Appl. No.: 13/971,844

(22) Filed: Aug. 21, 2013

(30) Foreign Application Priority Data
Apr. 3, 2013 (TW) 102112150

(51) Int. Cl. G06F 3/01

(52) U.S. Cl. CPC G06F 3/01
USPC 345/156

(57) ABSTRACT

An input device of an electronic device and a setting method thereof are provided. In the setting method, a setting path is displayed on a display unit of the electronic device, and the input device is set according to the setting path depicted by the input device.

### CROSS-REFERENCE TO RELATED APPLICATION

This application claims the priority benefit of Taiwan application serial no. 102112150, filed on Apr. 3, 2013. The entirety of the above-mentioned patent application is hereby incorporated by reference herein and made a part of this specification.

### BACKGROUND OF THE INVENTION

1. Field of the Invention

The present invention generally relates to an input device, and more particularly, to an input device of an electronic device and a setting method thereof.

2. Description of Related Art

Conventionally, a display panel is used for displaying information and output signals from the system, while other input devices are used for inputting signals to the system. A touch panel is a display panel which can receive user inputs through the user's touch actions. Namely, a touch panel offers both input and output functions and allows the user to interact with the display panel or the system coupled to the display panel. For example, touch panels can be applied to cell phones, notebook computers, and tablet computers in order to bring a diversified input experience to the users.

Touch panels (or touch screens) have many different designs, such as resistive touch panels, surface-wave touch panels, capacitive touch panels, and infrared touch panels. Regardless of the type of a touch panel, its purpose is to offer a convenient input experience to the user. For example, resistive touch panels, surface-wave touch panels, capacitive touch panels, and infrared touch panels can all be operated by using a finger or a stylus. However, existing touch panels still need to be improved even though they can offer the users very intuitional operation experiences.

### SUMMARY OF THE INVENTION

Accordingly, the present invention is directed to an input device of an electronic device and a setting method thereof, in which a diversified operation experience is brought to the user, and operating the electronic device and the input device is made very convenient.

The present invention provides a setting method of an input device. The input device is adapted to an electronic device having a display unit. The setting method includes following steps. A setting path is displayed on the display unit, where the setting path indicates setting parameters of the input device. The setting path depicted by the input device is identified. The input device is set according to the setting path depicted by the input device.

According to an embodiment of the present invention, the step of identifying the setting path depicted by the input device further includes following steps. Coordinate patterns detected by the input device are identified. The setting path depicted by the input device is determined according to the coordinate patterns.

According to an embodiment of the present invention, the step of setting the input device according to the setting path depicted by the input device further includes setting the input device according to a depiction sequence of the setting path.

According to an embodiment of the present invention, the setting method further includes transmitting the setting parameters of the input device to the electronic device.

The present invention provides an input device of an electronic device. The electronic device has a display unit. The input device includes a detection unit and a processing unit. The detection unit detects a setting path that is displayed on the display unit and depicted by the input device, where the setting path indicates setting parameters of the input device. The processing unit is coupled to the detection unit. The processing unit identifies the setting path depicted by the input device and sets the input device according to the setting path depicted by the input device.

According to an embodiment of the present invention, the display unit has a plurality of coordinate patterns, each of the coordinate patterns indicates a coordinate position on the display unit, and the coordinate patterns are formed on a surface of the display unit or inside the display unit through a process.

According to an embodiment of the present invention, the detection unit further detects the coordinate patterns, and the processing unit further identifies the coordinate patterns detected by the input device and determines the setting path depicted by the input device according to the coordinate patterns detected by the input device.

According to an embodiment of the present invention, the processing unit further sets the input device according to a depiction sequence of the setting path.

According to an embodiment of the present invention, the setting parameters of the input device include a user name, a serial number, a device name, and attributes of the input device or a matching relationship between the input device and the electronic device.

According to an embodiment of the present invention, a display area of the display unit includes a plurality of setting areas, and each of the setting areas is used for setting a different one of the setting parameters of the input device.

According to an embodiment of the present invention, the input device further includes a wireless transmission unit coupled to the processing unit. The wireless transmission unit transmits the setting parameters, position information, or input operation information of the input device to the electronic device.

As described above, in the present invention, a setting path is displayed on a display unit, and an input device is set according to the setting path depicted by the input device. Thereby, a user can set up the input device or operate an electronic device in a very intuitional way, and operating the electronic device and the input device is made very convenient.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of an electronic device and an input device according to an embodiment of the present invention.

FIGS. 2A-2C are diagrams of setting paths displayed on a display unit according to an embodiment of the present invention.

FIGS. 3A-3D are diagrams of setting paths displayed on a display unit according to another embodiment of the present invention.

FIG. 4 is a diagram of a display area on a display unit according to an embodiment of the present invention.

FIG. 5 is a diagram of an electronic device and an input device according to another embodiment of the present invention.

FIG. 6 is a flowchart of a method for setting an input device of an electronic device according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

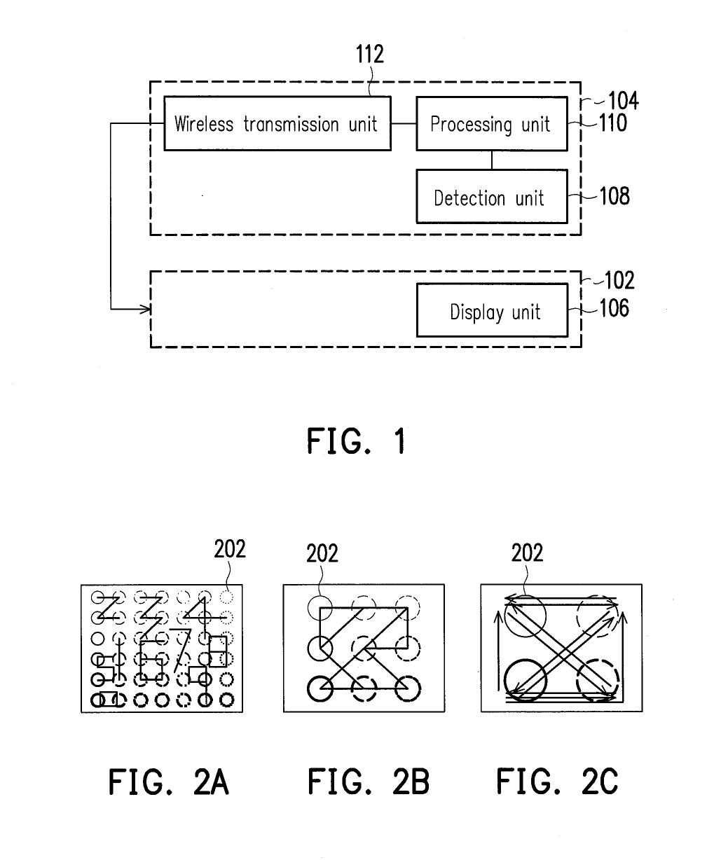

FIG. 1 is a diagram of an electronic device and an input device according to an embodiment of the present invention. Referring to FIG. 1, the input device 104 is used for performing input operations on the electronic device 102. The electronic device 102 has a display unit 106. The input device 104 includes a detection unit 108, a processing unit 110, and a wireless transmission unit 112. The processing unit 110 is coupled to the detection unit 108 and the wireless transmission unit 112. The electronic device 102 is an electronic product with a display screen, such as an ePaper display, a TV, a notebook computer, a desktop computer, a tablet computer, or a cell phone. The input device 104 is a device used for performing input operations on the electronic device 102, such as a stylus, a touch ring, a mouse, a track ball, a cell phone, or a tablet computer.

The display unit 106 of the electronic device 102 may be a display panel or a touch display panel. The display unit 106 displays a setting path. The setting path indicates setting parameters of the input device 104. The setting parameters of the input device 104 include a user name, a serial number, a device name, and attributes of the input device 104 or a matching relationship between the input device 104 and the electronic device 102. For example, when the input device 104 is a stylus, the setting parameters of the input device 104 are the brush size and color of the stylus. Because the setting parameters of the input device 104 include the user name, the serial number, the device name, or the matching relationship between the input device 104 and the electronic device 102, the attributes of the stylus can be personalized according to the user's operation habit, and the same stylus can be adapted to different electronic devices.

The detection unit 108 detects the setting path that is displayed on the display unit 106 and depicted by the input device 104. The processing unit 110 identifies the setting path depicted by the input device 104 and sets the input device 104 according to the setting path depicted by the input device 104. The wireless transmission unit 112 transmits the setting parameters, position information, or input operation information of the input device 104 to the electronic device 102. FIGS. 2A-2C are diagrams of setting paths displayed on a display unit according to an embodiment of the present invention. As shown in FIGS. 2A-2C, the setting paths displayed on the display unit 106 may be figures, geometrical patterns, or lines. However, a setting path displayed on the display unit 106 is not limited to foregoing examples and may also be any other texts, symbols, or patterns.

The setting parameters of the input device 104 that are corresponding to the setting path can be set when the input device 104 depicts the setting path displayed on the display unit 106, and the setting parameters of the input device 104 can be transmitted to the electronic device 102 through the wireless transmission unit 112. Herein it is assumed that the setting paths in FIGS. 2A-2C are used for Bluetooth matching. Conventionally, if Bluetooth matching is to be carried out between the input device 104 and the electronic device 102, a plurality of matching numbers has to be input to the input device 104. While in the present embodiment, the Bluetooth matching can be accomplished by simply depicting the setting path displayed on the display unit 106 by using the input device 104, which is much more convenient than the conventional technique. For example, in FIG. 2A, the Bluetooth matching between the input device 104 and the electronic device 102 can be accomplished by depicting the number “2160”. Or, in FIG. 2B or FIG. 2C, the Bluetooth matching can be accomplished by simply depicting the corresponding geometrical pattern or line.

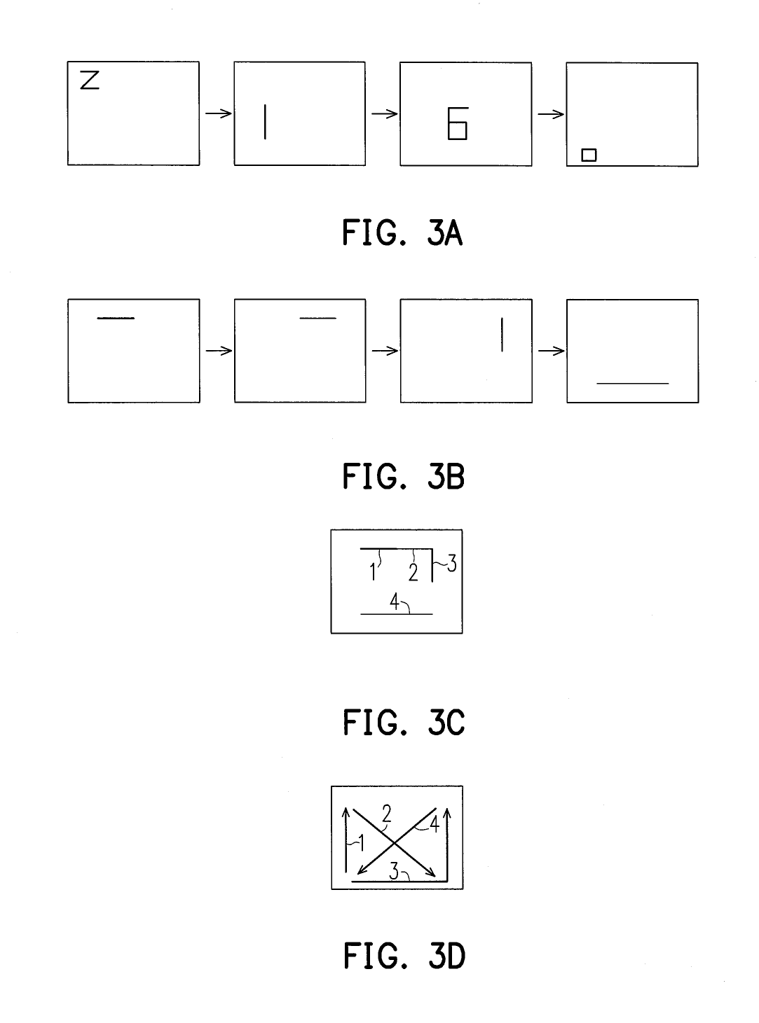

It should be noted that besides depicting the numbers, geometrical patterns, or lines displayed on the display unit 106, the depiction process can be defined to set the input device 104. FIGS. 3A-3D are diagrams of setting paths displayed on a display unit according to another embodiment of the present invention. In FIG. 3A, the display unit 106 sequentially displays the numbers “2”, “1”, “6”, and “0”. Thus, the input device 104 has to depict the setting path in the sequence of “2”, “1”, “6”, and “0”. In FIG. 3B, the setting path is composed of 4 lines displayed in a predetermined sequence. Thus, the input device 104 has to depict the setting path in the display sequence of the lines. In FIG. 3C, the setting path is also composed of 4 lines. However, unlike that illustrated in FIG. 3B, the display unit 106 displays the 4 lines all at once and displays the depiction sequence beside the lines, so that the input device 104 can depict the setting path according to the displayed sequence. Additionally, the depiction sequence may also be indicated by the pattern of the lines (for example, different dotted or solid lines, or different sizes or colors of the lines). In FIG. 3D, the setting path is composed of 4 lines. However, unlike that illustrated in FIG. 3C, in the setting path depiction illustrated in FIG. 3D, beside the depiction sequence, it is further indicated that the depiction direction of the lines has to follow the direction indicated by the arrows.

To be specific, in FIGS. 2A-2C, the display unit 106 has a plurality of coordinate patterns 202, and the coordinate patterns 202 are formed on a surface of the display unit 106 or inside the display unit 106 through a process. For the convenience of description, the coordinate patterns 202 are enlarged in FIGS. 2A-2C. While in a real application, the coordinate patterns 202 are almost invisible to human eyes and are distributed on the display unit 106 without affecting the display quality of the display unit 106. The coordinate patterns 202 may have different geometrical patterns. In the present embodiment, the coordinate patterns 202 are round-shaped, and the coordinate patterns 202 at different coordinate positions have different line sizes or have openings of different sizes, positions, or numbers. Thus, the coordinate patterns 202 indicate different coordinate positions on the display unit 106. It should be noted that the present embodiment is only an exemplary embodiment but not intended to limit the scope of the present invention, and in other embodiments, the coordinate patterns 202 may be other geometrical patterns or symbols, such as rectangles or hexagons.

The detection unit 108 detects the coordinate patterns 202 on the display unit 106. The processing unit 110 identifies the coordinate patterns 202 detected by the detection unit 108 and determines the setting path corresponding to the path depicted by the input device 104 according to the detected sequence of the coordinate patterns 202, so as to set the input device 104 accordingly. The detection unit 108 may be a complementary metal-oxide-semiconductor (CMOS) camera or a charge coupled device (CCD) camera, and which can capture the coordinate patterns 202 on the display unit 106.

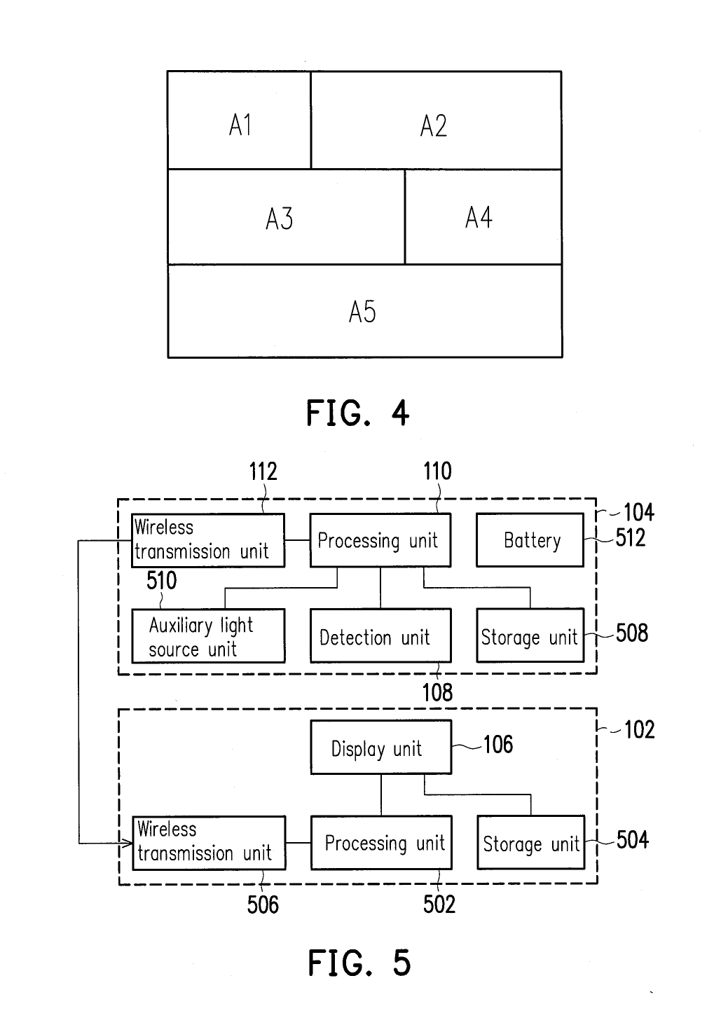

It should be noted that in some embodiments the display area on the display unit 106 of the electronic device 102 can be divided into a plurality of setting areas, and each setting area is used for setting a different setting parameter of the input device. FIG. 4 is a diagram of a display area on a display unit according to an embodiment of the present invention. In the present embodiment, the display area of the display unit 106 includes setting areas A1-A5, where the setting area A1 is used for inputting digits 0-9, the setting area A2 is used for inputting English letters A-Z, the setting areas A3 and A4 are used for setting attributes (for example, the user, serial number, and device name) of the input device 104, and the setting area A5 is used for setting the matching relationship between the input device 104 and the electronic device 102. By partitioning the display area of the display unit 106, the same setting path has different definitions in different setting areas, so that the pattern of the setting path is further simplified, and the setting of the input device 104 is made more convenient.

As described above, by displaying a setting path on the display unit 106 and setting the input device 104 according to the setting path depicted by the input device 104, a user is allowed to set the input device 104 or operate the electronic device 102 in a very intuitional way, and accordingly operating the electronic device 102 and the input device 104 is made very convenient.

FIG. 5 is a diagram of an electronic device and an input device according to another embodiment of the present invention. Referring to FIG. 5, the electronic device 102 further includes a processing unit 502, a storage unit 504, and a wireless transmission unit 506. The processing unit 502 is coupled to the display unit 106, the storage unit 504, and the wireless transmission unit 506. When the input device 104 is set, the processing unit 502 converts related setting information of the input device 104 into a setting path and controls the display unit 106 to display the setting path. Herein the setting information of the input device 104 may be device information, universally unique identifier (UUID), or device name, and which is converted by the processing unit 502 into a simple setting path to be depicted by the input device 104, so that the setting of the input device 104 is simplified. The storage unit 504 stores the setting information and conversion information of the corresponding setting path, where the processing unit 502 converts the setting information according to the conversion information. The wireless transmission unit 506 receives a signal from the input device 104 to obtain the attributes or setting parameters of the input device 104.

The input device 104 further includes a storage unit 508, an auxiliary light source unit 510, and a battery 512. The storage unit 508 and the auxiliary light source unit 510 are coupled to the processing unit 110. The battery 512 is coupled to the detection unit 108, the processing unit 110, the wireless transmission unit 112, the storage unit 508, and the auxiliary light source unit 510. To simplify the drawing, the couplings between foregoing elements are not illustrated in FIG. 5. The storage unit 508 stores the conversion information corresponding to the setting information and the corresponding setting path. The processing unit 110 restores an identified setting path into setting information according to the conversion information and sets the input device 104 according to the setting information. Besides, the processing unit 110 transmits the setting parameters of the input device 104 to the electronic device 102 through the wireless transmission unit 112. The auxiliary light source unit 510 emits an auxiliary light to the coordinate patterns 202 so that the processing unit 110 can identify the coordinate patterns 202 easily. In addition, the battery 512 supplies power to the detection unit 108, the processing unit 110, the wireless transmission unit 112, the storage unit 508, and the auxiliary light source unit 510.

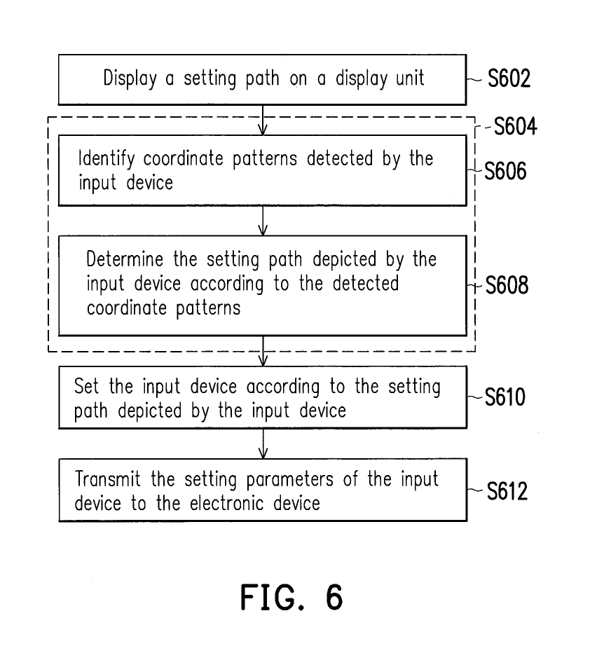

FIG. 6 is a flowchart of a method for setting an input device of an electronic device according to an embodiment of the present invention. Referring to FIG. 6, the setting method of the input device 104 of the electronic device 102 includes following steps. First, a setting path is displayed on a display unit (step S602), where the setting path indicates the setting parameters of the input device, such as the user name, serial number, device name, or attributes of the input device or the matching relationship between the input device and the electronic device. Then, the setting path depicted by the input device is identified (step S604). The display unit may be a display panel or a touch display panel, and which has a plurality of coordinate patterns. The coordinate patterns are formed on a surface of the display unit or inside the display unit through a process, and each coordinate pattern indicates a coordinate position on the display unit. To be specific, the step of identifying the setting path depicted by the input device further includes following steps. First, the coordinate patterns detected by the input device are identified (step S606). Then, the setting path depicted by the input device is determined according to the detected coordinate patterns (step S608). Herein when the setting path depicted by the input device is determined according to the detected coordinate patterns, the depiction sequence of the setting path can be further taken into consideration. Next, the input device is set according to the setting path depicted by the input device (step S610). Finally, the setting parameters of the input device are transmitted to the electronic device (step S612).

It should be noted that in other embodiments, the display area of the display unit may be further partitioned into a plurality of setting areas. The setting areas are used for setting different setting parameters of the input device, so that the setting path is simplified and using the input device 104 is made very convenient.

As described above, in the present invention, a setting path is displayed on a display unit, and an input device is set according to the setting path depicted by the input device. Thereby, a user can set up the input device or operate an electronic device in a very intuitional way, and operating the electronic device and the input device is made very convenient. In some embodiments, the display area of the display unit can be further partitioned into a plurality of setting areas to further simplify the setting path and improve the convenience of using the input device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A setting method of an input device, wherein the input device is adapted to an electronic device having a display unit, the setting method comprising:
displaying a setting path on the display unit, wherein the setting path indicates setting parameters of the input device;
identifying the setting path depicted by the input device; and
setting the input device according to the setting path depicted by the input device.

2. The setting method according to claim 1, wherein the display unit has a plurality of coordinate patterns, each of the coordinate patterns indicates a coordinate position on the display unit, and the coordinate patterns are formed on a surface of the display unit or inside the display unit through a process.

3. The setting method according to claim 2, wherein the step of identifying the setting path depicted by the input device comprises:
identifying the coordinate patterns detected by the input device; and
determining the setting path depicted by the input device according to the detected coordinate patterns.

4. The setting method according to claim 1, wherein the step of setting the input device according to the setting path depicted by the input device further comprises:
setting the input device according to a depiction sequence of the setting path.

5. The setting method according to claim 1, wherein the setting parameters of the input device comprise a user name, a serial number, a device name, and attributes of the input device or a matching relationship between the input device and the electronic device.

6. The setting method according to claim 5, wherein a display area of the display unit comprises a plurality of setting areas, and each of the setting areas is used for setting a different one of the setting parameters of the input device.

7. The setting method according to claim 1 further comprising:
transmitting the setting parameters of the input device to the electronic device.

8. An input device of an electronic device, wherein the electronic device has a display unit, the input device comprising:
a detection unit, detecting a setting path that is displayed on the display unit and depicted by the input device, wherein the setting path indicates setting parameters of the input device; and
a processing unit, coupled to the detection unit, identifying the setting path depicted by the input device, and setting the input device according to the setting path depicted by the input device.

9. The input device according to claim 8, wherein the display unit has a plurality of coordinate patterns, each of the coordinate patterns indicates a coordinate position on the display unit, and the coordinate patterns are formed on a surface of the display unit or inside the display unit through a process.

10. The input device according to claim 9, wherein the detection unit further detects the coordinate patterns, and the processing unit further identifies the coordinate patterns detected by the input device and determines the setting path depicted by the input device according to the coordinate patterns detected by the input device.

11. The input device according to claim 8, wherein the processing unit further sets the input device according to a depiction sequence of the setting path.

12. The input device according to claim 8, wherein the setting parameters of the input device comprise a user name, a serial number, a device name, and attributes of the input device or a matching relationship between the input device and the electronic device.

13. The input device according to claim 12, wherein a display area of the display unit comprises a plurality of setting areas, and each of the setting areas is used for setting a different one of the setting parameters of the input device.

14. The input device according to claim 8, wherein the input device further comprises:
a wireless transmission unit, coupled to the processing unit, transmitting the setting parameters, a position information, or an input operation information of the input device to the electronic device.
